(19) United States
(12) Patent Application Publication
(10) Pub. No.: US 2021/0033374 A1
(43) Pub. Date: Feb. 4, 2021

(54) ANTI-BACKLASH MECHANISM

(71) Applicant: BAE Systems Information and Electronic Systems Integration Inc., Nashua, NH (US)

(72) Inventor: Francis M. Feda, Sudbury, MA (US)

(73) Assignee: BAE Systems Information and Electronic Systems Integration Inc., Nashua, NH (US)

(21) Appl. No.: 16/524,762

(22) Filed: Jul. 29, 2019

(51) Int. Cl. F42B 10/64; F16H 57/12

(52) U.S. Cl. CPC F42B 10/64; F16H 2057/127; F16H 57/12

(57) ABSTRACT

A system for eliminating backlash associated with a precision guided projectile is provided. The system includes a canard assembly including at least one canard that is moveable, a rotation assembly operably engaged with the at least one canard, an input shaft of the rotation assembly, an output shaft of the rotation assembly operably engaged with the input shaft and operably engaged with the at least one canard of the canard assembly, a mechanical ground, an anti-backlash mechanism operably engaged with the output shaft and operably engaged with the mechanical ground, and a bias torque of the anti-backlash mechanism applied to the output shaft. The anti-backlash mechanism eliminates the backlash between the input shaft and the output shaft.

### TECHNICAL FIELD

The present disclosure generally relates to precision guided projectiles. More particularly, the present disclosure relates to control actuation systems (CASs) for precision guided projectiles. Specifically, the present disclosure relates to anti-backlash mechanisms for CASs of precision guided projectiles.

### BACKGROUND

### Background Information

Artillery fuzes are typically attached to a leading end of an artillery projectile prior to launch from a gun platform forming precision guided projectiles. Next generation artillery fuzes provide precision guidance capability that may correct for firing errors and steer the projectile to a desired target impact point. Artillery fuzes with precision guidance capability typically incorporate a control actuation system (CAS), which typically includes a motor, a transmission, and an output shaft for each canard output axis. Backlash in the mechanical transmission of the CAS results in an uncertainty in canard angular position which can impact guidance performance and accuracy.

One method of mitigating backlash effects in the mechanical transmission of the CAS includes introducing a dither motion into the canard position, which, in effect, wiggles the canard about a desired angular position to average out the effects of the backlash; however, this method requires a significant amount of energy to power the drive motor in comparison to the energy otherwise required to simply position the canards for guidance purposes alone if the backlash effects were not present.

### SUMMARY

There remains a need in the art for an improved system and method for eliminating backlash effects in control actuation systems (CASs) of artillery projectiles, which includes precision guided projectiles. The present disclosure addresses these and other issues. More particularly, the system and method of the present disclosure are directed to eliminating backlash, which removes the need for dithering, and thus allows for a smaller, lighter weight, lower cost electrical power source. Size and weight reductions can benefit artillery projectile stability, maximum range and allow more flexibility in packing other components within the fuze.

In one aspect, an exemplary embodiment of the present disclosure may provide a system for eliminating backlash associated with a precision guided projectile, comprising a canard assembly including at least one canard that is moveable; a rotation assembly operably engaged with the at least one canard; an input shaft of the rotation assembly; an output shaft of the rotation assembly operably engaged with the input shaft and operably engaged with the at least one canard of the canard assembly; a mechanical ground; an anti-backlash mechanism operably engaged with the output shaft and operably engaged with the mechanical ground; and a bias torque of the anti-backlash mechanism applied to the output shaft; wherein the anti-backlash mechanism eliminates the backlash between the input shaft and the output shaft. In one example, the anti-backlash mechanism is a spring, such as a linear spring or a torsion spring.

The system further includes a first mechanical stop of the rotation assembly operably engaged with the input shaft; and a second mechanical stop of the rotation assembly operably engaged with the first mechanical stop and operably engaged with the output shaft; wherein the anti-backlash mechanism eliminates the backlash between the first mechanical stop and the second mechanical stop. In one example, the first mechanical stop and the second mechanical stop remain in constant contact. In one example, the first mechanical stop and the second mechanical stop are gears. In another example, the first mechanical stop and the second mechanical stop are link members operably engaged with at least one rotation mechanism.

The system further includes a drive torque of the rotation assembly configured to rotate the at least one canard of the canard assembly in a first direction and a second direction; wherein the bias torque opposes the drive torque when the at least one canard of the canard assembly moves in one of the first direction and the second direction. The system further includes a rotation angle of the output shaft that is less than approximately one hundred eighty degrees. In one example, the at least one canard of the canard assembly is a roll canard.

In another aspect, an exemplary embodiment of the present disclosure may provide a method for eliminating backlash associated with a precision guided projectile, comprising eliminating, with an anti-backlash mechanism, backlash between an input shaft of a rotation assembly and an output shaft of the rotation assembly; wherein the anti-backlash mechanism is free of applying a dithering motion to the precision guided projectile.

The method further includes operably engaging a canard assembly including at least one canard that is moveable with the output shaft of the rotation assembly; operably engaging the anti-backlash mechanism with a mechanical ground and the output shaft; and applying a bias torque of the anti-backlash mechanism to the output shaft. In one example, the anti-backlash mechanism is a spring, such as a linear spring or a torsion spring.

The method further includes operably engaging a first mechanical stop of the rotation assembly with the input shaft; operably engaging a second mechanical stop of the rotation assembly with the first mechanical stop and with the output shaft; and eliminating, with the anti-backlash mechanism, backlash between the first mechanical stop and the second mechanical stop.

The method further includes keeping the first mechanical stop and the second mechanical stop in constant contact with one another. The method further includes rotating, via a drive torque, the at least one canard of the canard assembly in a first direction and a second direction; wherein the bias torque opposes the drive torque when the at least one canard of the canard assembly moves in one of the first direction and the second direction. In one example, the at least one canard is a roll canard.

In another aspect, an exemplary embodiment of the present disclosure may provide a system for eliminating backlash associated with a precision guided projectile. The system includes a canard assembly including at least one canard that is moveable, a rotation assembly operably engaged with the at least one canard, an input shaft of the rotation assembly, an output shaft of the rotation assembly operably engaged with the input shaft and operably engaged with the at least one canard of the canard assembly, a mechanical ground, an anti-backlash mechanism operably engaged with the output shaft and operably engaged with the mechanical ground, and a bias torque of the anti-backlash mechanism applied to the output shaft. The anti-backlash mechanism eliminates the backlash between the input shaft and the output shaft.

Implementations of the techniques discussed above may include a method or process, a system or apparatus, a kit, or a computer software stored on a computer-accessible medium. The details or one or more implementations are set forth in the accompanying drawings and the description below. Other features will be apparent from the description and drawings, and form the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a side elevation view of a guided projectile in accordance with one aspect of the present disclosure;

FIG. 2 is partial front perspective view of the guided projectile;

FIG. 3 is a longitudinal cross-section of the guided projectile taken along line 3-3 of FIG. 2;

FIG. 4 is a side elevation view of a rotation assembly;

FIG. 5 is a cross section taken along line 5-5 of FIG. 4 showing a PRIOR ART rotation assembly;

FIG. 6 is an exemplary graph of the angular motion associated with a PRIOR ART method of dithering a roll axis of the guided projectile during flight;

FIG. 7 is a cross section taken along line 7-7 of FIG. 4 showing a first embodiment of a system for eliminating backlash in accordance with one aspect of the present disclosure;

FIG. 8A is a bottom view of a second embodiment of a system for eliminating backlash in accordance with one aspect of the present disclosure;

FIG. 8B section view taken off of line 8B-8B of FIG. 8A;

FIG. 9A is a bottom view of a third embodiment of a system for eliminating backlash in accordance with one aspect of the present disclosure;

FIG. 9B section view taken off of line 9B-9B of FIG. 9A;

FIG. 10 is a diagrammatic plan view of a fourth embodiment of a system for eliminating backlash in accordance with one aspect of the present disclosure; and

FIG. 11 is a flowchart in accordance with one aspect of the present disclosure.

### DETAILED DESCRIPTION

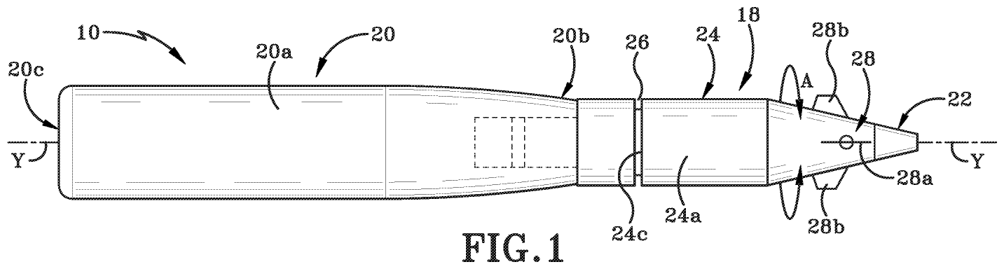

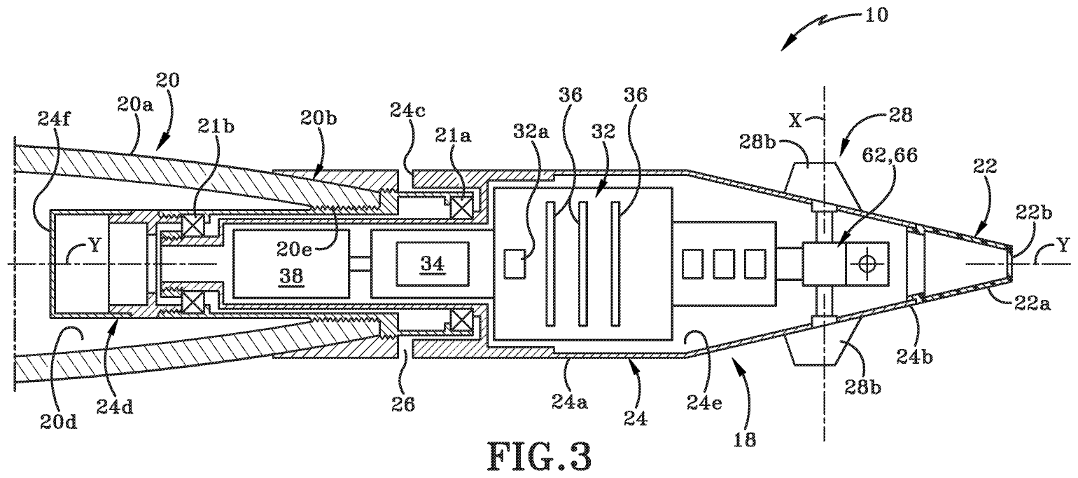

This disclosure relates to a system for eliminating backlash in control actuation systems (CASs) of precision guided projectiles. FIG. 1 through FIG. 3 shows a guided projectile 10. The guided projectile 10 includes a fuze 18 and a projectile body 20. Projectile body 20 may take any of a variety of different forms and may include an exterior wall 20a having a first end 20b (FIG. 3) and a second end 20c (FIG. 1). Wall 20a bounds and defines an interior cavity 20d and may be fabricated from a material, such as metal, that is structurally sufficient to enable projectile 10 to carry an explosive charge within interior cavity 20d. A coupling region 20e may be provided proximate first end 20b of projectile body 20 and is utilized to engage projectile body 20 and fuze 18 together. A pair of roll bearings 21a, 21b is provided that allows the fuze 18 to rotate (roll) relative to the projectile body 20. FIG. 3 shows forward roll bearing 21a and rear roll bearing 21b.

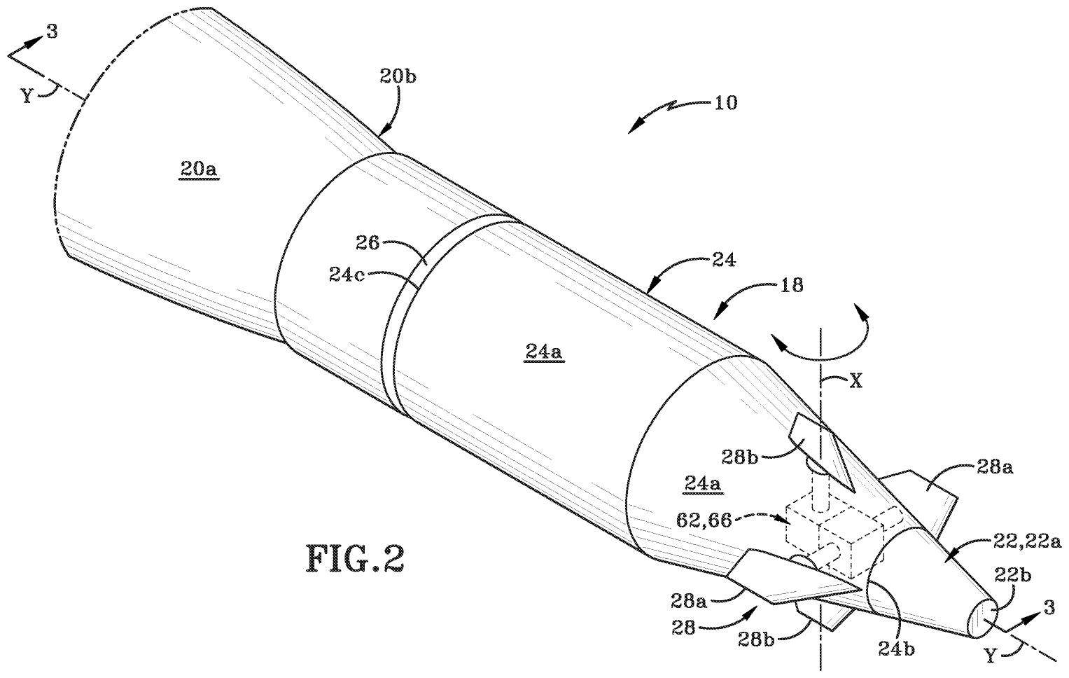

Referring to FIG. 2 and FIG. 3, fuze 18 includes a radome housing 22 and a fuze body 24 that are operatively engaged with each other. Radome housing 22 includes an exterior sidewall 22a that may be generally of a truncated conical shape. Radome housing 22 may further include a front end 22b and a rear end 22c (FIG. 3). Sidewall 22a and front end 22b bound and define an interior cavity 22d (FIG. 3) within which various components may be housed. Radome housing 22 forms the nose or leading end of fuze 18 and therefore of guided projectile 10.

As shown in FIG. 3, fuze body 24 includes an exterior sidewall 24a having a first end 24b (FIG. 2), an intermediate region 24c, and an extension 24d that extends rearwardly from intermediate region 24c. Extension 24d is of a smaller circumference than sidewall 24a and is adapted to be received within cavity 20d of projectile body 20. Sidewall 24a bounds and defines an interior cavity 24e within which a number of components are housed. Intermediate region 24c terminates in a second end 24f that is remote from first end 24b. Fuze 18 has a longitudinal axis Y, which may also be referred to as a roll axis Y, that extends between a central region of front end 22b and a central region of second end 24f.

First end 24b of fuze body 24 may be operatively engaged with rear end 22c of radome housing 22 or be integrally formed therewith. Extension 24d of fuze body 24 may be coupled to coupling region 20e of projectile body 20. A space 26 (FIG. 3) is defined between intermediate region 24c of fuze body 24 and a portion of coupling region 20e on projectile body 20. Extension 24d, which may be tubular in configuration, may be threadedly engaged with coupling region 20e. The engagement between fuze 18 and projectile body 20 may be one that permits fuze 18 to rotate relative to projectile body 20 and about longitudinal axis Y. This possible rotation is indicated by the arrow A in FIG. 1.

Referring still to FIG. 2 and FIG. 3, a canard assembly 28 may be provided on fuze body 24. Canard assembly 28 may include one or more lift canards 28a and one or more roll canards 28b. Canards 28a, 28b are utilized to provide stability and/or control to guided projectile 10 and are operatively engaged with a control actuation system (CAS) 62, which may also be referred to as a rotation assembly 62, located within interior cavity 24e of fuze body 24. In one example, the CAS 62 may serve as a mechanical ground 66 as further described below. Canards 28a, 28b are operated by control actuation system 62 to steer guided projectile 10 during its flight towards a remote target. More particularly, the at least one roll canard 28b is pivotably connected to a portion of the fuze 18 via the CAS 62 such that the roll canard 28b pivots about a pivot axis X. The pivot axis X of the roll canard 28b intersects the longitudinal axis Y. The roll canards 28b are located diametrically opposite from one another. The fuze 18 can control the pivoting movement of each roll canard 28b via the CAS 62. The roll canards 28b cooperate to control the roll orientation of the fuze 18 about the longitudinal axis Y while it is in motion after being fired from the launch assembly. More particularly, directly after launch, the projectile body 20 and the fuze 18 will be rapidly spinning, due the rifling of the gun barrel and the compression of the roll bearings 21a, 21b during launch acceleration, which lock the fuze 18 to the projectile body 20. Upon exiting the gun barrel, the projectile body 20 and the fuze 18 are no longer accelerating, the bearing compression is removed and the fuze 18 is free to spin about the roll axis Y, relative to the projectile body 20. The roll canards 28b cooperate to despin the fuze 18 and to hold the fuze 18 in a fixed rotational orientation relative to the earth while the projectile body 20 continues to spin at a high rate.

Referring still to FIG. 3, fuze 18 may further include a guidance, navigation, and control (GNC) assembly 32 located within cavity 24e. The function of the GNC assembly 32 is to navigate the guided projectile 10 to the impact point, and to develop control signals to the CAS 30 canards 28a, 28b for in-flight trajectory corrections as needed. As such, the GNC assembly 32 may include a Global Positioning System (GPS) receiver 32a and other components, such as, for example, at least one GPS antenna (not shown). Although not specifically illustrated herein, GNC assembly 32 may also include a plurality of other sensors, including, but not limited to, laser guided sensors, electro-optical sensors, imaging sensors, inertial navigation systems (INSs), inertial measurement units (IMUs), or any other sensors suitable or necessary for use on a guided projectile 10. These sensors may be provided in cavity 22d of radome housing 22 or in cavity 24e of fuze body 24 or in any other suitable location.

At least one non-transitory computer-readable storage medium 34, and at least one processor or microprocessor 36 may be housed within cavity 24e of fuze body 24. The storage medium 34 may include instructions encoded thereon that, when executed by the processor or microprocessor 36, implements various functions and operations to aid in guidance, navigation and control of guided projectile 10. A battery 38 and a capacitor 40 may be located within interior cavity 24e. Battery 38 may be operatively engaged with any of the aforementioned components that require power to operate.

It is to be understood that the placement of the various components within fuze 18 may be different from what is illustrated herein. In some examples, some of the above-mentioned components may be omitted from guided projectile 10. In other examples, additional components may be included in guided projectile 10. Some or all of the components may be operatively engaged with each other via wiring. Only some wiring has been illustrated in FIG. 3 for the sake of clarity of illustration. It will be understood that any type of connections may be provided between the various components within fuze 18 or any other location of the guided projectile 10.

Now that the guided projectile 10 has been described, the backlash problems associated with the guided projectile 10 as well as embodiments of the system for eliminating backlash associated with the guided projectile 10 will be described in greater detail. As stated above, artillery fuzes with precision guidance capability, which includes guided projectiles, typically incorporate a CAS 62 to which canards are operably engaged. Backlash associated with the CAS 62 results in an uncertainty in canard 28 position which can impact guidance performance and accuracy of the guided projectile 10.

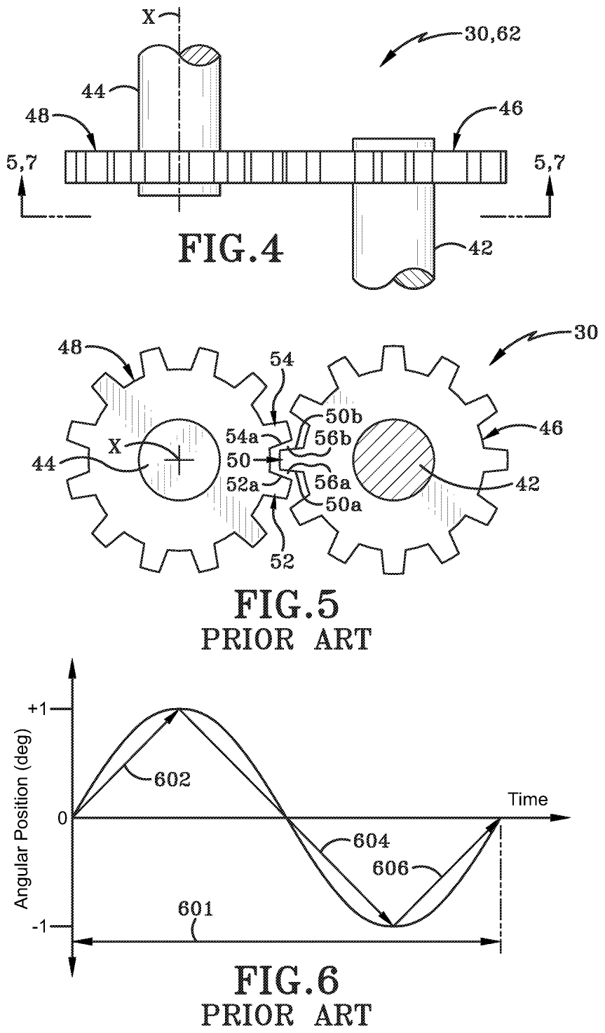

One example of backlash is described with reference to FIG. 4, which generally depicts a conceptual example of a CAS at 30, or rotation assembly 30, of the guided projectile 10, and with reference to FIG. 5, which generally depicts a conceptual PRIOR ART cross section of the rotation assembly 30 of FIG. 1. As shown in FIG. 4 and FIG. 5, the rotation assembly 30 includes an input shaft 42, an output shaft 44, a first mechanical stop 46, and a second mechanical stop 48. Although the input shaft 42, the output shaft 44, the first mechanical stop 46, and the second mechanical stop 48 of the rotation assembly 30 are shown as having a particular configuration, they are shown to conceptually depict the concept of backlash, and, as such, it is to be understood that the rotation assembly 30 may include other components configured in any suitable manner.

In this example, and with reference to FIG. 5, the first mechanical stop 46 and the second mechanical stop 48 are gears, and, as such, the first mechanical stop 46 may also be referred to as a drive gear 46 and the second mechanical stop 48 may be referred to as a driven gear 48. The drive gear 46 includes a first tooth 50 having a first edge 50a and a second edge 50b. The driven gear 48 includes a first tooth 52 having an edge 52a and a second tooth 54 having an edge 54a. The drive gear 46 drives the driven gear 48 which, in turn, rotates the output shaft 44 which rotates a canard 28b about the pivot axis X. The canard 28b is able to rotate freely because of a first gap 56a defined between the first edge 50a of the first tooth 50 and the edge 52a of the first tooth 52 and between the second edge 50b of the first tooth 50 and the edge 54a of the second driven tooth 54. The gaps 56a and 56b result from various mechanical tolerance and assembly variations, as well as from mechanical wear.

As stated above, a conventional method of mitigating backlash effects in associated with the CAS 30, or rotation assembly 30, includes introducing a dither motion into the canard 28b position, which, in effect, wiggles the canard 28b about a desired angular position to average out the effects of the backlash; however, this method requires a significant amount of energy to power a drive motor (not shown in FIG. 4 nor FIG. 5) in comparison to the energy otherwise required to simply position the canards 28b for guidance purposes alone if the backlash effects were not present as further described below. It will be understood that although dithering is typically only applied to the roll canard axis (i.e., the pivot axis X shown in FIG. 2) in the current state of the art, there is nothing that precludes dithering from being applied to the lift canard axis (not shown). As such, the teachings of the present disclosure are directed to being applied to the roll canard axis; however, the teachings of the present disclosure are also applicable to the lift canard axis in a similar manner.

FIG. 6 is an exemplary graph of the angular motion associated with a PRIOR ART method of dithering the roll canard 28b about the pivot axis X during flight. The graph represents angular position in degrees on the y-axis versus time on the x-axis. In this example, the dither motion had an amplitude of one degree, a rate of ten hertz (Hz), and the duration of flight was 156.5 seconds. The angular distance traveled per cycle, indicated by line 601, was four degrees, as indicated by lined arrows 602, 604, and 606, and therefore, total angular distance traveled is four times the peak amplitude, which is 4.0 degrees/cycle×10 cycles/second×156.5 seconds, which is equal to 6,250 degrees. It should be noted that the total distance is path independent.

The roll canard 28b motion about the pivot axis X due to the required guidance of the guided projectile 10 was also computed during the flight of the guided projectile 10 for this example, and the total value was 220.6 degrees. Therefore, the angular motion due to guidance was 220.6 degrees and the angular motion due to dither was 6,250 degrees. Therefore, the total angular motion to realize the dither motion, and also the corresponding electrical energy necessary to operate the drive train motor of the guided projectile 10 is 6250/220.6, which is equal to 28.4 times the angular motion and energy consumption required for the guidance function alone. Thus, the dither motion consumes 96.5 percent of the total energy being utilized by the motor of the guided projectile 10. In turn, eliminating the dither motion and the associated electrical energy necessary to drive the motor of the guided projectile 10 results in a significant reduction in the energy consumption required to operate the drive axis motor during flight.

Thus, and in accordance with embodiments, techniques and architecture are disclosed herein for a system for eliminating backlash by removing the need for dither motion and the associated electrical energy necessary to drive the motor of the guided projectile 10. Removing the need for the dither motion results in a significant reduction in the energy consumption required to operate the drive axis motor during of the guided projectile during flight.

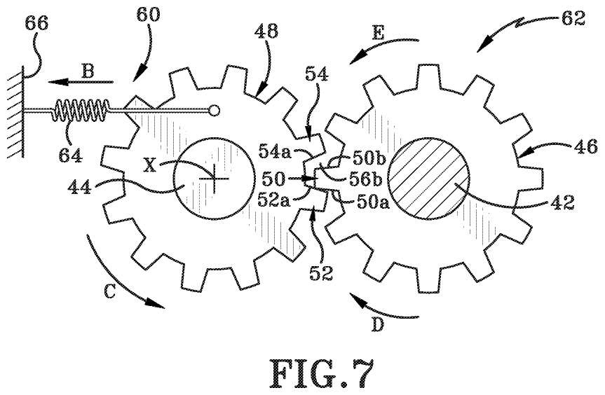

FIG. 7, which is a cross section view taken from FIG. 5, depicts a partial view of a first embodiment of a system for eliminating backlash associated with a guided projectile 10 generally depicted at 60. The system 60 includes a rotation assembly 62, an anti-backlash mechanism 64, and a mechanical ground 66. The rotation assembly 62 includes some components that are substantially similar to the rotation assembly 30 depicted in PRIOR ART FIG. 5, and, as such, those components are denoted with similar reference numerals. In particular, the rotation assembly 62 of the system 60 includes the input shaft 42, the output shaft 44, the first mechanical stop 46, and the second mechanical stop 48 of the PRIOR ART rotation assembly 30 of FIG. 5.

The first mechanical stop 46 and the second mechanical stop 48 are gears, and, as such, the first mechanical stop 46 may also be referred to as a drive gear 46 and the second mechanical stop 48 may be referred to as a driven gear 48. The drive gear 46 includes a first tooth 50 having a first edge 50a and a second edge 50b. The driven gear 48 includes a first tooth 52 having an edge 52a and a second tooth 54 having an edge 54a. The drive gear 46 drives the driven gear 48 which, in turn, rotates the output shaft 44 which rotates a canard 28b about the pivot axis X. However, in contradistinction to the rotation assembly 30 of FIG. 5, the rotation assembly 62 of the system does not include the first gap 56a while the second gap 56b increases in size. Therefore, the canard 28b is not able to rotate freely as the first edge 50a of the first tooth 50 is in constant contact with the edge 52a of the first tooth 52.

It should be noted that the pivot axis X and the roll axis Y are arbitrary. That is, FIG. 2 shows the pivot axis X passing through the roll canard 28b and FIG. 7 shows the pivot axis X as passing through the output shaft 44. However, FIG. 2 also shows a lift canard 28a rotating about its own independent axis, which is not labeled in FIG. 1. The teachings shown in FIG. 7 can also be applied to the lift canards 28a about their own independent axis.

As shown in FIG. 7, this is accomplished via the anti-backlash mechanism 64, which, in this embodiment, is a linear spring. More particularly, the anti-backlash mechanism 64 is operably engaged with the driven gear 48 on one end and the mechanical ground 66 on the other end. The mechanical ground 66 is non-rotating. It should be noted that, in this example, a spring connected to a mechanical ground is viable, since the canard motion is small, and doesn't move through a full rotation. If the canard did move through a full rotation, the spring-to-mechanical ground approach would not be a viable approach.

Generally, while the guided projectile 10 is in flight, aerodynamic forces due to, at least in part, wind loading on the canards 28b create a torque about the pivot axis X. If backlash is present, the canards 28b can flop around within the space allowed by the backlash, due to changes in wind direction, in-flight vibration, etc. The bias torque must be strong enough to hold the canard 28b against the mechanical stop at all times. The mechanical stop itself is then moved by the motor, to reposition the canard 28b as needed.

More particularly, and in operation, the anti-backlash mechanism 64 applies a pull force, indicated by arrow B in FIG. 7, upon the driven gear 48 which produces a bias torque, indicated by arrow C in FIG. 7, forcing engagement of the first edge 50a of the drive tooth 50 and the edge 52a of the first tooth 52 eliminating backlash, and maintaining this engagement through the full range of motion of the driven gear 48. Further, uncertainty in rotational position of the driven gear 48 and the output shaft 44 is removed allowing angular position of the guided projectile 10 to be precisely determined, improving overall guidance accuracy.

A drive torque (not shown), which is applied to the drive gear 46 to rotate the drive gear in a first direction indicated by arrow D in FIG. 7 and a second direction indicated by arrow E in FIG. 7, must be sufficient to overcome the anti-backlash mechanism-induced bias torque when rotating the driven gear 48 in the second direction, which, in this example, is a clockwise direction. Likewise, the anti-backlash mechanism 64 must be of sufficient tension to overcome any opposing torque, which, in this example, is torque applied by the drive torque, which may be applied to the driven gear 48, which, in this example, is a clockwise torque. That is, when the driven gear 48 is rotated in the clockwise direction, the drive motor needs to work harder than if the spring were not present, to overcome the spring force in order to rotate the driven gear 48. It should be noted that except for frictional losses and other non-linearities, the anti-backlash approach of the present disclosure consumes no net electrical energy. This is beneficial in that it avoids the potential need for a larger battery (and associated size, weight and cost).

In one example, the bias torque must be greater than or equal to at least approximately 0.69 pound force inches (lbf-in). In one example, a rotation angle (not shown) of the output shaft 44 is less than or equal to approximately one hundred eighty degrees. In another example, the rotation angle of the output shaft is less than or equal to approximately thirty degrees. One benefit of the rotation angle being less than or equal to approximately one hundred eighty degrees is that the cost and complexity of utilizing commercially available zero-backlash gear sets, which allow for full rotation of the output shaft, can be avoided.

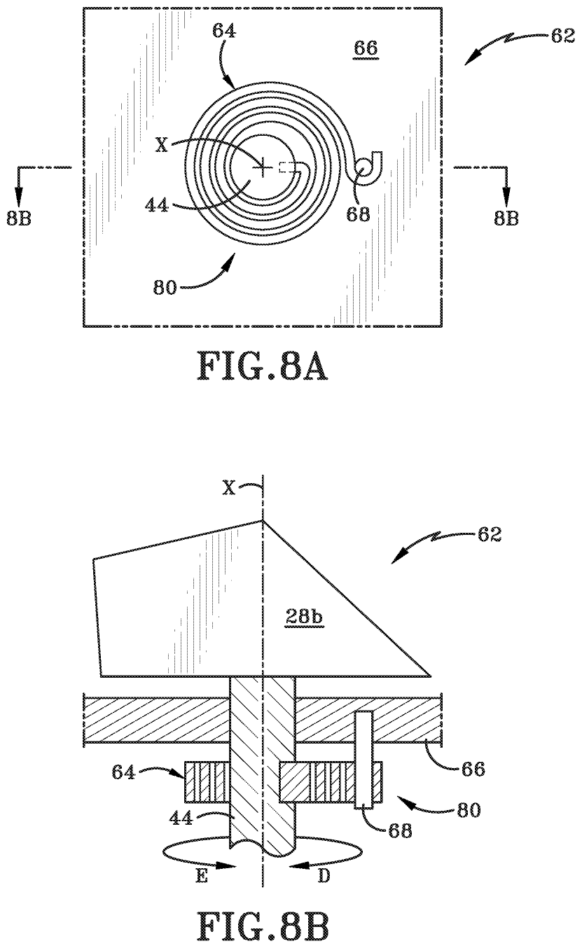

FIG. 8A is a partial bottom view of a second embodiment of a system for eliminating backlash associated with a guided projectile 10 generally depicted at 80 with some components removed for clarity. FIG. 8B is a cross section taken along line 8B-8B of FIG. 8A. The system 80 is substantially identical to the system 60 of FIG. 7 in structure and function with a few exceptions/additions that will be discussed hereafter in greater detail. As shown in FIG. 8A and FIG. 8B, instead of the anti-backlash mechanism 64 being a linear spring, the anti-backlash mechanism 64 is a torsion spring and the system 80 further includes an engagement mechanism 68, which, in this embodiment, is a pin extending from the mechanical ground 66. In this embodiment, the torsion spring is operably engaged with the driven gear 48 on one end and engagement mechanism 68 on the other end. The torsion spring operates in a similar manner as the linear spring and will not be further discussed herein. FIG. 8B also depicts the canard 28b connected to the output shaft 44.

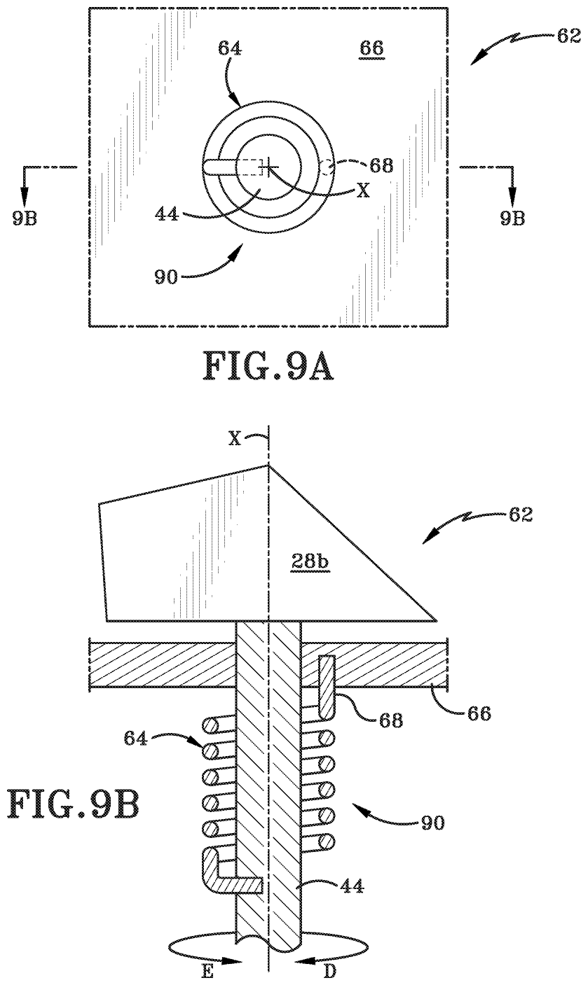

FIG. 9A is a partial bottom view of a third embodiment of a system for eliminating backlash associated with a guided projectile 10 generally depicted at 90 with some components removed for clarity. FIG. 9B is a cross section taken along line 9B-9B of FIG. 9A. The system 90 is substantially identical to the system 80 of FIG. 8A except that the anti-backlash mechanism 64 is a different type of torsion spring compared to the torsion spring of FIG. 8A and FIG. 8B. The torsion spring of FIG. 9A and FIG. 9B operates in a similar manner as the torsion spring of FIG. 8A and FIG. 8B and will not be further discussed herein. FIG. 9B also depicts the canard 28b connected to the output shaft 44.

It will be understood that there are many varieties of torsion springs and, as such, various embodiments can be envisioned using different torsion spring types depending on the particular application.

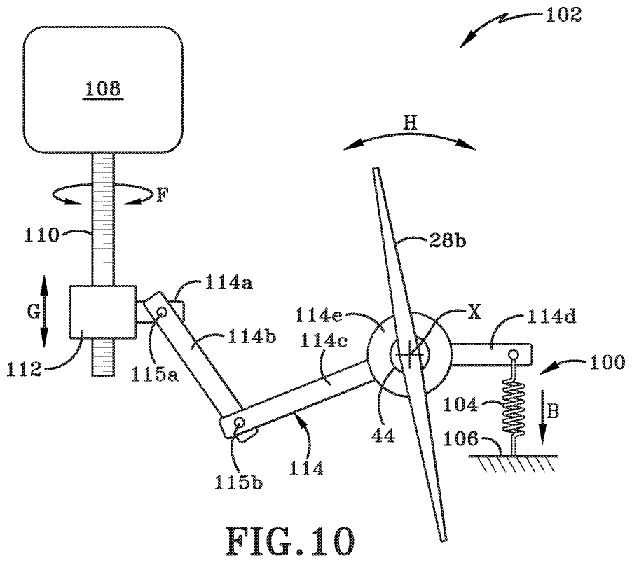

FIG. 10 depicts a fourth embodiment of a system for eliminating backlash associated with guided projectile 10 generally depicted at 100. The system 100 includes a rotation assembly 102, an anti-backlash mechanism 104, and a mechanical ground 106. The rotation assembly 102 includes a drive motor 108, a rotating device 110, such as a lead screw 110, a translation device 112, such as a drive nut, a plurality of link members 114, and an output shaft 116.

As shown in FIG. 10, the drive motor 108 is operably engaged with the lead screw 110 and the lead screw 110 is operably engaged with the drive nut 112. In this embodiment, the system 100 includes a first link member 114a, a second link member 114b, a third link member 114c, a fourth link member 114d, and a rotation mechanism 114e. The plurality of link members 114 may be elongated members; however, the plurality of link members 114 may be any suitable shape and have any suitable configuration. With continued reference to FIG. 10, the drive nut 112 is operably engaged with the first link member 114a, the first link member 114a is operably engaged with the second link member 114b about a first pivot point 115a, the second link member 114b is operably engaged with the third link member 114c about a second pivot point 115b, the third link member 114c is operably engaged with the rotation mechanism 114e, and the rotation mechanism 114e is operably engaged with the output shaft 116. The fourth link member 114d is operably engaged with the rotation mechanism 114e and the anti-backlash mechanism 104 which, in this embodiment, is an extension/compression spring. The anti-backlash mechanism 104 is operably engaged with the mechanical ground 106. The mechanical ground is non-rotating. The output shaft 116 is operably engaged with the canards 28b. The overall backlash motion as seen at the canard 28b can arise due to backlash contributions at each moving interface of FIG. 10. That is, due to mechanical tolerances, there can be backlash between the lead screw 110 and the drive nut 112, and at each rotational joint in the linkage. The anti-backlash mechanism 104 biases the entire linkage in one direction, holding both components of each moveable joint in contact throughout the range of motion of the canard 28b as further described below.

In operation, the drive motor 108 rotates the lead screw 110 in a direction indicated by arrow F, which, in turn, linearly moves the drive nut 112 in a direction indicated by arrow G. The drive nut 112 rotates the first link member 114a, the second link member 114b and the third link member 114c which rotates the rotation mechanism about the pivot axis X. The rotation mechanism 114e rotates the output shaft 116 and the output shaft rotates the canards 28b about the pivot axis X in a direction indicated by arrow H. The anti-backlash mechanism 104 applies a pull force, indicated by arrow B, upon the fourth link member 114d which produces a bias torque (not shown), eliminating backlash between the system 100, including backlash between at least the operable engagement of the lead screw 110 and the drive nut 112, the first pivot point 115a, and the second pivot point 115b. Further, removing the backlash allows the angular position of the guided projectile 10 to be precisely determined, improving overall guidance accuracy.

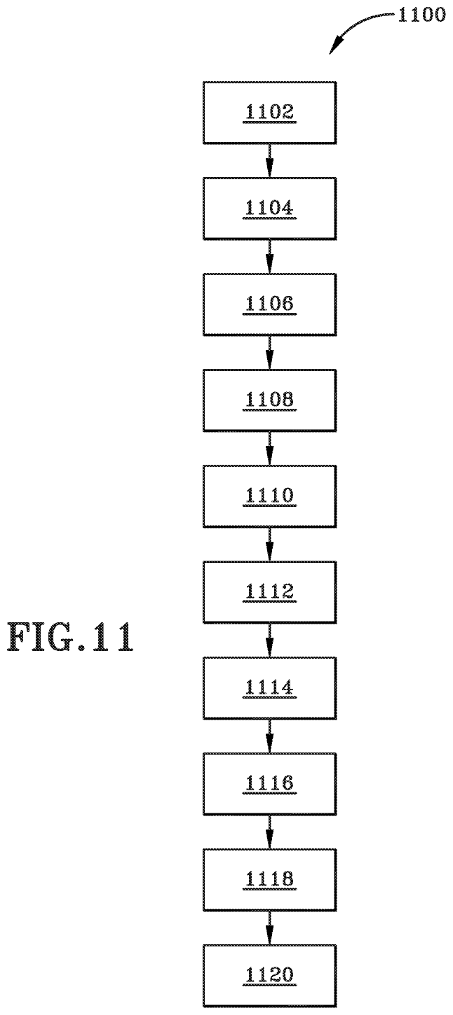

FIG. 11 depicts a flowchart of a method for eliminating backlash associated with a precision guided projectile generally at 1100. The method 1100 includes eliminating, with an anti-backlash mechanism, backlash between an input shaft of a rotation assembly and an output shaft of the rotation assembly; wherein the anti-backlash mechanism is free of applying a dithering motion to the precision guided projectile, which is shown generally at 1102.

The method 1100 further includes operably engaging a canard assembly including at least one canard that is moveable with the output shaft of the rotation assembly, which is shown generally at 1104. The method 1100 further includes operably engaging the anti-backlash mechanism with a mechanical ground and the output shaft, which is shown generally at 1106. The method further includes applying a bias torque of the anti-backlash mechanism to the output shaft, which is shown generally at 1108. In one example, the anti-backlash mechanism is a spring, such as a linear spring or a torsion spring.

The method 1100 further includes operably engaging a first mechanical stop of the rotation assembly with the input shaft, which is shown generally at 1110. The method 1100 further includes operably engaging a second mechanical stop of the rotation assembly with the first mechanical stop and with the output shaft, which is shown generally at 1112. The method 1100 further includes eliminating, with the anti-backlash mechanism, backlash between the first mechanical stop and the second mechanical stop, which is shown generally at 1114.

The method 1100 further includes keeping the first mechanical stop and the second mechanical stop in constant contact with one another, which is shown generally at 1116.

The method 1100 further includes rotating, via a drive torque, the at least one canard of the canard assembly in a first direction and a second direction; wherein the bias torque opposes the drive torque when the at least one canard of the canard assembly moves in one of the first direction and the second direction, which is shown generally at 1118. Stated otherwise, the drive torque must exceed the bias torque in order to rotate the output shaft. However, when rotating in one direction, the bias torque will be opposing the drive torque, and, therefore, the motor requires more energy to overcome the bias torque than if the bias torque was not present. Conversely, when rotating in the opposite direction, the bias torque is in the same direction as the drive torque, and, therefore, the motor need produce less torque than if the bias torque were not present, and thus will use less energy. When the bias torque opposes the output shaft rotation, the required drive torque is equal to the required output torque plus the bias torque. When the bias torque is in the same direction as the output shaft rotation (i.e., the bias torque helps to rotate the output shaft, the required drive torque is equal to the required output torque minus the bias torque. The method 1100 further includes providing a roll canard as the at least one canard, which is shown generally at 1120.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch electrical contact pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the FIGS. is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A system for eliminating backlash associated with a precision guided projectile, comprising:
a canard assembly including at least one canard that is moveable;
a rotation assembly operably engaged with the at least one canard;
an input shaft of the rotation assembly;
an output shaft of the rotation assembly operably engaged with the input shaft and operably engaged with the at least one canard of the canard assembly;
a mechanical ground;
an anti-backlash mechanism operably engaged with the output shaft and operably engaged with the mechanical ground; and
a bias torque of the anti-backlash mechanism applied to the output shaft; wherein the anti-backlash mechanism eliminates the backlash between the input shaft and the output shaft.

2. The system of claim 1, wherein the anti-backlash mechanism is a spring.

3. The system of claim 2, wherein the spring is a linear spring.

4. The system of claim 2, wherein the spring is a torsion spring.

5. The system of claim 1, further comprising:
a first mechanical stop of the rotation assembly operably engaged with the input shaft; and
a second mechanical stop of the rotation assembly operably engaged with the first mechanical stop and operably engaged with the output shaft; wherein the anti-backlash mechanism eliminates the backlash between the first mechanical stop and the second mechanical stop.

6. The system of claim 5, wherein the first mechanical stop and the second mechanical stop remain in constant contact.

7. The system of claim 5, wherein the first mechanical stop and the second mechanical stop are gears.

8. The system of claim 5, further comprising:
at least one rotation mechanism; wherein the first mechanical stop and the second mechanical stop are link members operably engaged with the at least one rotation mechanism.

9. The system of claim 1, further comprising:
a drive torque of the rotation assembly configured to rotate the at least one canard of the canard assembly in a first direction and a second direction; wherein the bias torque opposes the drive torque when the at least one canard of the canard assembly moves in one of the first direction and the second direction.

10. The system of claim 1, further comprising:
a rotation angle of the output shaft that is less than approximately one hundred eighty degrees.

11. The system of claim 1, wherein the at least one canard of the canard assembly is a roll canard.

12. A method for eliminating backlash associated with a precision guided projectile, comprising:
eliminating, with an anti-backlash mechanism, backlash between an input shaft of a rotation assembly and an output shaft of the rotation assembly; wherein the anti-backlash mechanism is free of applying a dithering motion to the precision guided projectile.

13. The method of claim 1, further comprising:
operably engaging a canard assembly including at least one canard that is moveable with the output shaft of the rotation assembly;
operably engaging the anti-backlash mechanism with a mechanical ground and the output shaft; and
applying a bias torque of the anti-backlash mechanism to the output shaft.

14. The method of claim 13, wherein the anti-backlash mechanism is a spring.

15. The system of claim 13, wherein the spring is a linear spring.

16. The system of claim 13, wherein the spring is a torsion spring.

17. The method of claim 12, further comprising:
operably engaging a first mechanical stop of the rotation assembly with the input shaft;
operably engaging a second mechanical stop of the rotation assembly with the first mechanical stop and with the output shaft; and
eliminating, with the anti-backlash mechanism, backlash between the first mechanical stop and the second mechanical stop.

18. The method of claim 17, further comprising:
keeping the first mechanical stop and the second mechanical stop in constant contact with one another.

19. The method of claim 12, further comprising:
rotating, via a drive torque, the at least one canard of the canard assembly in a first direction and a second direction; wherein the bias torque opposes the drive torque when the at least one canard of the canard assembly moves in one of the first direction and the second direction.

20. The method of claim 13, wherein the at least one canard is a roll canard.
